(19) United States
(12) Patent Application Publication
(10) Pub. No.: US 2010/0098961 A1
(43) Pub. Date: Apr. 22, 2010

(54) Thermal barrier coatings using intermediate TCE nanocomposites

(76) Inventors: Otto Gregory, Wakefield, RI (US); Markus Downey, Narragansett, RI (US); Stephen Wnuk, Lunenburg, MA (US); Vincent Wnuk, Lunenburg, MA (US)

Correspondence Address: Gauthier & Connors LLP, Suite 2300, 225 Franklin Street, Boston, MA, 02110, US

(21) Appl. No.: 11/543,665

(22) Filed: Oct. 5, 2006

Related U.S. Application Data
(63) Continuation of application No. PCT/US05/12669, filed on Apr. 15, 2005.
(60) Provisional application No. 60/562,341, filed on Apr. 15, 2004.

(51) Int. Cl. B32B 15/04; F02B 77/02; B32B 18/00; B32B 9/00

(52) U.S. Cl. 428/472; 252/62

(57) ABSTRACT

An intermediate thermal expansion coefficient coating including an NiCoCrAly alloy. The coating contains nanoparticles of the alloy and alumina. A nanocomposite coating is placed on metals to protect them from high gas temperatures by providing thermal insulation. The nanocomposite coating includes a bond coating, an intermediate thermal expansion coefficient coating, and a ceramic top coat. The intermediate thermal expansion coefficient coating comprises a NiCoCrAly alloy and allumina nanoparticles and has a ceramic top coat which is based on zirconi or high purity alumina.

### BACKGROUND OF THE INVENTION

Ceramic thermal barrier coatings (TBS's) are commonly used in aircraft engines and power generation turbines to reduce the metal interface temperatures and thus, reduce the oxidation and corrosion of the nickel and cobalt based superalloys exposed to the hot gases. The integrity and durability of these TBS's is critical for the safe and economical operation of gas turbine engines. As advanced engine designs rely more on state-of-the art coating technologies and new high-temperature materials are being developed, the operating temperatures of turbine engines are being pushed to higher levels. However, the gain in thermodynamic efficiency realized by operating at high temperatures can be offset by the reduced fatigue life of the state of the art TBS's being employed today. A typical TBC system consists of a metallic bond coat that is used to impart oxidation resistance to the underlying nickel or cobalt based superalloy. And a ceramic top coat for thermal and/or electrical insulation. The bond coat is typically a NiCoCrAlY alloy that has been designed to form a uniform aluminum oxide layer for oxidation resistance and a ceramic top coat based on zirconia or high purity alumina, depending on the application. Both coatings are typically sprayed onto the surface of engine components using thermal spray techniques. Similar in construction and design to standard TBC's used for thermal protection are the dielectric coatings used for thermal spray instrumentation. However, in the case of thermal spray instrumentation, the dielectric coatings must not only protect the superalloy components at the higher temperatures but they must also provide electrical isolation as well. In the latter application, wire wound strain gages and/or temperature sensors are typically imbedded in a thermal sprayed dielectric, which has already been coated with a metallic bond coat.

The main failure mode in TBC's is delamination/decohesion at the metallic bond coat/ceramic top coat interface. In one type of TBC failure, the mismatch in thermal expansion coefficient between the ceramic top coat and the metallic bond coat can lead to delamination/decohesion at the metallic bond coat/ceramic top coat interface. During heating and cooling, the metallic bond coat expands and contracts to a much greater extent than the ceramic top coat. This difference in TCE leads to high stresses at the NiCoCrA1Y bond coat/alumina top coat interface. When these stresses exceed the fracture stress, the coating fails. Another failure mode in TBC's can occur when the rough conformation of the thermal-sprayed bond coat leads to the development of interfacial stresses. Recent research has shown that the bond coat exhibits a relatively rough interface, the peaks and valleys of which act as stress concentrators and crack initiation sites. As the NiCoCrAlY bond coat expands upon heating, the peaks will expand into the ceramic and act as a wedge with very high stresses developing at the interface. Once a crack is formed it will tend to propagate through the ceramic. However, nanocomposite coatings composed of NiCoCrA1Y and alumina, deposited between the metallic bond coat and the ceramic top coat, can reduce the interfacial stresses and improve the fatigue life of the TBC's.

U.S. Pat. No. 5,320,909 to Scharman et al., describes a thermal barrier coating for metal articles subjected to rapid thermal cycling and includes a metallic bond coat deposited on the metal article, at least on MCrAlY/ceramic layer deposited on the bond coat, and a ceramic top layer deposited on the MCrAlY/ceramic layer. The M is Fe, Ni, Co or a mixture of Ni and Co. The ceramic is mullite or Al₂O₃.

U.S. Pat. No. 4,481,237 to Bosshart et al., is directed to a coating applied to a metal substrate and comprises a metallic bond coat, a first interlay of metal/ceramic material, a second interlayer of metal/ceramic material having an increased proportion of ceramic and a final ceramic layer. These coatings have not achieved the desired service life.

There are ceramic thermal barrier coatings known in the art, however, they have not achieved the desired results for us in aircraft engines and power generation turbines.

### SUMMARY OF THE INVENTION

Thermal barrier coatings (TBC) are used in aircraft engines and power generation turbines to protect critical components from high gas temperatures by providing thermal insulation to the underlying nickel and cobalt based superalloys. In an effort to increase the fatigue life of thermally sprayed TBC's, an intermediate thermal expansion coefficient (TCE) coating, that would reduce interfacial stresses at the metallic bond-coat-ceramic overcoat interface. A nanocomposite coating was developed with intermediate thermal expansion properties, i.e. a TCE between the metallic bond coat and the ceramic top coat. The intermediate TCE coating fills the valleys associated with the rough thermally-sprayed bond coats, which also reduced interfacial stresses by reducing the peak to valley distances. Nanocomposite coatings having intermediate TCE's significantly improved the fatigue life of thermal-sprayed ceramic coatings when compared to state-of-the-art TBC's.

A nanocomposite with the desired thermal properties using a simple mixture rule, a coating with TCE values varying between those of the metallic and ceramic phases was developed and in so doing, the stresses experienced during heating and cooling were dramatically reduced. Due to the nanoscale dimensions of the individual phases present in the coatings, we were able to effectively fill the valleys in the thermally sprayed bond coat, and reduce the peak to valley distance and the associated interfacial stress.

An object of the present invention is to provide an intermediate thermal expansion coefficient coating of an NiCoCrAly alloy.

It is a further object of the invention to provide a coating containing nanoparticles.

It is another object of the present invention to provide a nanocomposite coating which is placed on metals to protect them from high gas temperatures by providing thermal insulation, wherein the nanocomposite coating includes a bond coating, an intermediate thermal expansion coefficient coating, and a ceramic top coat.

Another object of the invention is to provide a nanocomposite with reduced thermal conductivity whereby the air-cooled superalloy could remain cooler due to the reduced thermal conductivity of the nanocomposite.

### DESCRIPTION OF THE DRAWINGS

Other objects, features and advantages of the present invention will become more apparent as the description proceeds with reference to the accompanying drawings, wherein:

FIG. 1 is a top view of an embodiment of the invention;

FIG. 2 is a sectional view of FIG. 1 taken along lines 1-1;

FIG. 3 schematic showing the results of co-sputtering;

FIG. 4 is a photograph of a thermal fatigue test;

FIG. 5 is a schematic representation of the effects of nanocomposite thickness and composition on the fatigue life of TBC's;

FIG. 6 is an SEM micrograph of thermally fatigued intermediate coating;

FIG. 7 is a schematic representation of the NiCoCrAlY/alumina interface and associated stresses; and

FIG. 8 is a TEM micrograph of an as-deposited NiCoCrAlY/alumina nanocomposite coating.

### DETAILED DESCRIPTION OF THE INVENTION

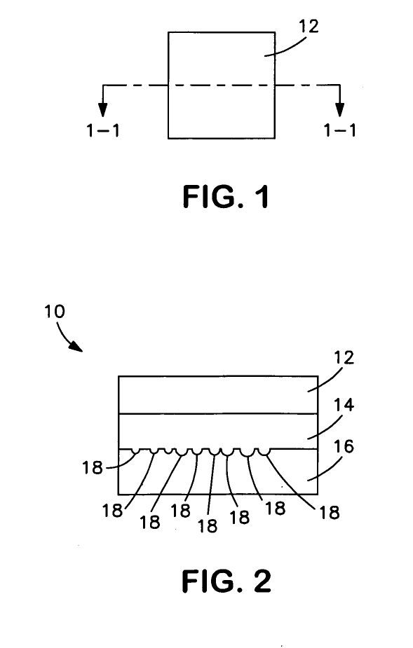

FIG. 1 shows a top view of an embodiment of the invention and FIG. 2 shows a sectional view of FIG. 1 taken along lines 1-1. Referring to FIG. 2, a composite 10 comprises a first layer 1, e.g. an alumina top coat, a second layer 14, e.g. an intermediate alumina/NiCoCrAlY coat, and a third layer 16, e.g. a NiCoCrAlY bond coat having valleys 18 therein. The second layer 14 is designed such that when it is applied to the third layer 16 it impregnates at least a portion of at least one of the valleys 18. It is designed to facilitate the substantial matching of the thermal expansion properties of the third layer 16 and the first layer 12 when the second layer 14 is disposed between the third layer 16, and the first layer 12 and functions as a low thermoconductive material to reduce the transfer of the heat from the first layer to the third layer 16.

Inconel 718 substrates, is an alloy which is a precipitation hardened nickel-based superalloy, commonly used for the hot sections of gas turbine engines, due to its excellent oxidation resistance and high temperature strength. The Inconel 718 test coupons measured 1 in×3 in×⅛ in. After grit blasting, the test coupons were thermal-sprayed with a Praxair N171 bond coat and high purity alumina ceramic top coat. Praxair 171 is a proprietary NiCoCrA1Y bond coat and was sprayed to a nominal thickness of 0.01 mm. An intermediate TCE coating was applied to the as-sprayed bond coat by rf sputtering at a power of 400 watts. After deposition of the intermediate TCE coating, a layer of pure alumina (Al₂O₃) was thermal-sprayed onto the bond coated Inconel 718 test coupons to form two ¼ in wide strips of high purity alumina. The multiple strips of alumina allowed more than one data point from a single Inconel 718 test coupon to be obtained.

### Nanocomposite Coatings

After the NiCoCrA1Y bond coat was deposited onto the Inconel 718 test coupon, a nanocomposite coating was formed on the as-sprayed surface by rf sputtering from a composite sputtering target. Sputtering was the deposition method of choice, since it is a non-equilibrium process, which will ultimately yield nanometer sized particles that are a requisite for the intermediate TCE coating. In addition to being a non-equilibrium process, sputtering is also a low temperature deposition process that greatly reduces the tendency for particle agglomeration relative to other deposition processes such as plasma spraying or CVD. Thermally sprayed intermediate TCE coats were attempted in the past but the particle sizes were such that the coatings actually reduced the fatigue life of the TBC's. Therefore, a composite sputtering target was fabricated by thermally spraying different mixtures of NiCoCrAIY and alumina onto a stainless steel backing plate. The as-sprayed surfaces were examined by scanning electron microscopy (SEM) to determine the extent of mixing and the distribution of the two phases in the mixture. After pre-cleaning, the NiCoCrA1Y coated substrates were placed directly under the composite sputtering target in an MRC 8667 RF sputtering machine and intermediate TCE coatings of the desired thickness were deposited onto the bond coated Inconel 718 substrates.

### Heat Treatment of the NiCoCrA1Y Bond Coat

The intermediate TCE coatings were tested in conjunction with heat treatment in reduced oxygen partial pressures, to selectively oxidize the aluminum and chromium in the bond coat and ultimately form a mixture of protective alumina and chromia scales. To accomplish this, the NiCoCrA1Y coated substrates were sealed in a horizontal tube furnace, which was continually purged with dry nitrogen gas to selectively oxidize the material and form a graded coating. The tube furnace temperature was ramped to 954° C. at 3° C./minute ramp and held for 1 hour. When a temperature of 954° C. was reached, the substrates were held for 20 hours, after which the temperature was ramped down to room temperature.

### Combinatorial Chemistry

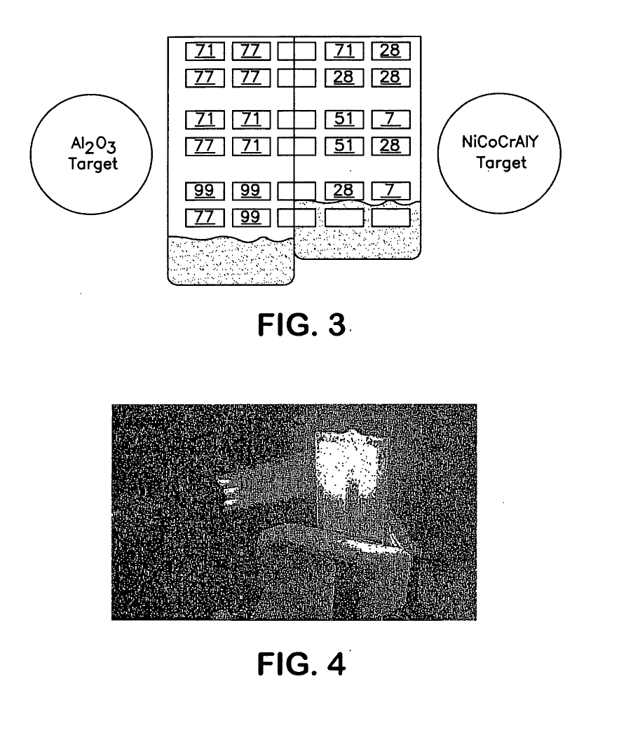

In an effort to screen the large number of NiCoCrA1Y/alumina compositions for the ideal intermediate TCE coating, a combinatorial chemistry method was employed. Inconel 718 test coupons were bond coated with NiCoCrA1Y (Praxair N171) and covered with a shadow mask to expose small rectangular regions on the surface of the substrate. These windows in the shadow mask yielded more than 22 combinatorial libraries (or uniquely defined composition regions) depending on the relative distance from each sputtering target as shown in FIG. 3. The Inconel 718 substrates were covered with the shadow mask and placed in an MRC 8667 rf sputtering machine that was capable of co-sputtering from 3 different targets simultaneously. Therefore, by placing the substrates between a NiCoCrA1Y and alumina target, material from both targets would be mixed in the plasma and deposited through the windows created by the shadow mask. In this way, each of the 22 combinatorial libraries yielded a unique composition depending on its location relative to each of the targets. The combinatorial libraries were then thermally sprayed with a ceramic top coat and thermally fatigued in a horizontal tube furnace. The combinatorial libraries were heated to 1150° C., held at temperature for one hour and allowed to air cool to 150° C., which constituted one thermal cycle. After cooling to 150° C., the libraries were reheated to 1150° C. and the cycle was repeated. Each of the libraries was inspected upon cooling for any signs of failure. The composition of the library with the greatest fatigue life was determined by using scanning electron microscopy (SEM) with energy dispersion spectroscopy of x-rays. (EDS) The composition of the library with the longest fatigue life was also used as the basis for preparing a composite sputtering target by thermal-spraying the determined mixture onto a stainless steel backing plate.

### Thermal Fatigue Testing

The Inconel 718 test coupons were fatigue tested in a computer controlled burner rig shown in FIG. 4 wherein the Inconel 718 test coupon was coated with 2 strips of thermal-sprayed alumina. In the burner rig, the test coupons were heated to 1200° C. using an oxy-propane torch and held at this temperature for one hour. At this point, the coupons were removed from the flame and the back of the coupon was blasted with 8° C. nitrogen gas, and in so doing, the test coupon was cooled to 60° C. within a few minutes. After cooling, the test coupons were moved back into the flame and heated to 1200° C. This heating and cooling cycle constituted one thermal fatigue cycle. The fatigue life of the sample was measured in terms of cycles to failure, where failure was determined as a result of any spalling or cracking of the alumina top coat.

The fatigue life of the individual combinatorial libraries ranged from 7 to 99 cycles to failure, as indicated in white. It was found that the combinatorial libraries which survived 99-cycles to failure had a nominal composition of 40 wt % NiCoCrA1Y/60 wt % alumina. Based on this result, a mixture of this composition was thermal-sprayed onto a stainless steel backing plate to make a composite sputtering target. Initially, a 2.4 μm thick intermediate TCE coating based on this composition was sputtered onto several bond coated coupons. An alumina top coat was thermal-sprayed onto these coupons and they were subsequently cycled in a computer controlled burner rig. A slight decrease in the fatigue life was observed with these samples when compared to the fatigue life of as-sprayed samples (13 vs. 14 cycles to failure). This negative result was attributed to the fact that the original combinatorial chemistry experiment was done in a tube furnace instead of the burner rig and the alumina content in the intermediate TCE coating was too high for this mode of testing.

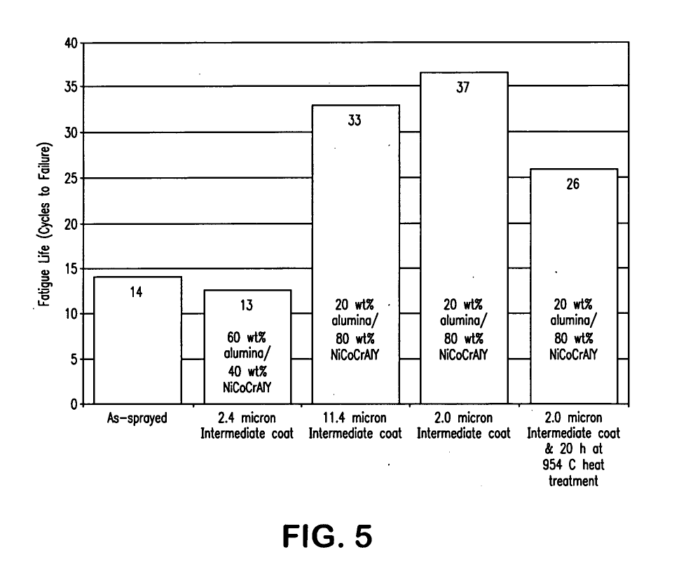

Therefore, a second composite sputtering target was prepared by thermal spraying a mixture of 80 wt % NiCoCrA1Y and 20 wt % alumina onto a water cooled, stainless steel backing plate. Since the two different powder types were intimately mixed during thermal spraying, a composite of the two materials at very small length scales could be produced. This became the source material for the nanocomposite that was prepared by conventional sputtering, since the spatial distribution of the phases in the sputtered material could be maintained at even smaller length scales. A second series of bond coated Inconel 718 substrates was thermally sprayed with high purity alumina after an 11.4 μm thick intermediate TCE coating was applied by sputtering. A 136% increase in fatigue life was realized when the 11.4 μm intermediate TCE coating was incorporated into the TBC; i.e. 33 cycles to failure as compared to 14 cycles to failure for the baseline thermal sprayed coating. The effect of thickness and composition of these intermediate TCE coatings on fatigue life was also investigated. When a 2.0 μm thick intermediate TCE coating was sputtered onto a thermally sprayed N171 bond coated substrate and cover coated with thermal sprayed alumina, a 161% increase in the fatigue life was realized after thermal fatigue testing; i.e. 37 cycles to failure as compared to 14 cycles to failure for the baseline thermal sprayed coating. When this coating was used in conjunction with a post deposition heat treatment in nitrogen, an 86% increase in the fatigue life was observed for the substrates prepared with a nanocomposite TCE coating; i.e. 26 cycles to failure as compared to 14 cycles to failure for the baseline thermal sprayed coating. The effect of nanocomposite TCE coating thickness and composition on the fatigue life of the thermal sprayed TBC's is shown in FIG. 5.

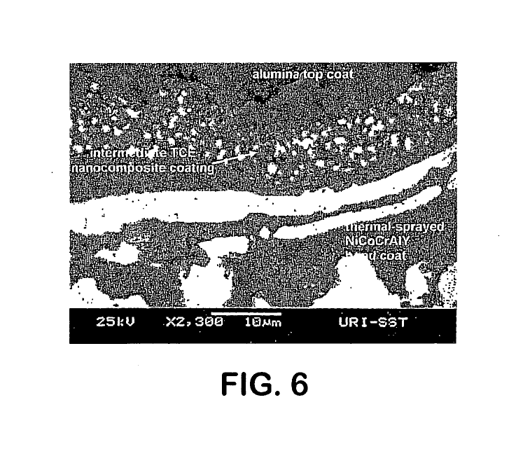

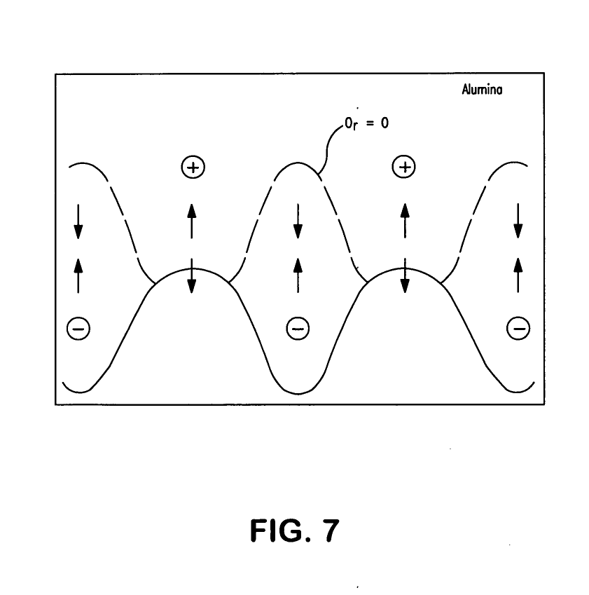

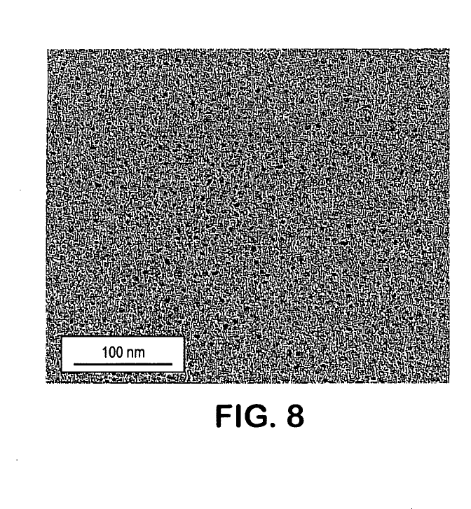

Several thermally sprayed intermediate TCE coatings were also attempted to increase fatigue life of the TBC's but the particle sizes were such that the coatings actually reduced the fatigue life of the TBC's. In order to form an effective intermediate TCE coating, the particle size has to be much smaller than the peak to valley distance, which was nominally 2-5 μm for the present TBC's. If the particle size of the intermediate coat is larger than the peak to valley distance a new layer is formed over the bond coat instead of the desired fill in of the valleys. The sputtered intermediate coat has conclusively shown that the desired result of extending the fatigue life could be achieved by controlling the particle size at these small length scales. As indicated in FIG. 6, the sputtered intermediate coating at the top of the micrograph shows a much smaller particle size than the thermal-sprayed bond coat beneath it. It is clearly visible that many of the particles in the sputtered intermediate layer are in the nanometer size range. This micrograph was taken in backscatter mode in the SEM, which is sensitive to the atomic number and hence the heavier elements appear lighter in the micrograph. The light phase (NiCoCrA1Y particles) was uniformly dispersed in the alumina particles or darker phase in the micrograph. Energy dispersive X-ray spectroscopy (EDS) was used to confirm the composition of the light and dark particles. Also visible in the micrograph is the wavy conformation of the thermal-sprayed layer at the bond coat/intermediate TCE coat interface. A schematic representation of the NiCoCrA1Y/alumina interface and the associated stresses is shown in FIG. 7. The nanometer dimensions of the particles comprising the composite coatings at this rough interface were critical to extending the fatigue life of the TBC's and larger particles proved to be deleterious to the fatigue life. The sputtered layer also exhibited a much higher density than the thermal-sprayed layer, based on examination by SEM.

There appears to be little or no dependence of thickness of the intermediate TCE coating on fatigue life. Thinner intermediate TCE coatings showed only a slight improvement ill fatigue life relative to the thicker intermediate TCE coatings. In all cases however, the sizes of the individual particles comprising the intermediate TCE coatings remained relatively constant. FIG. 6 shows a transmission electron microscope (TEM) image of an as-deposited intermediate coating consisting of 80 wt % NiCoCrA1Y and 20 wt % alumina at a magnification of 100,000×. To determine the average particle size and distribution of phases in the nanocomposite coating, a 100 Å thick coating was sputtered onto a TEM grid and examined in the as-deposited condition. In the TEM micrograph of FIG. 6, the NiCoCrAtY particles are the light phase and the alumina particles are the dark phase. The size of the individual particles (nanometer sized particles) comprising the as-deposited intermediate TCE coating is evident in the TEM micrograph as well. The relatively large amounts of NiCoCrA1Y present in the micrograph can be explained in part by the very different sputtering yields between the two materials; i.e. the sputtering yield of alumina is an order of magnitude smaller than that of NiCoCrA1Y. Hence, in a composite target comprised of these two materials, the NiCoCrA1Y phase would sputter considerably faster than the alumina phase.

The fatigue life of thermal barrier coatings employing an intermediate TCE coating was significantly increased. By incorporating an intermediate TCE coating into the TBC, with thermal properties averaged between those of the NiCoCrA1Y bond coat and alumina top coat, it was possible to reduce interfacial stresses and extend the lifetime of state of the art TBC's. Towards this end, nanocomposite coatings were developed with the desired composition and particle size using combinatorial chemistry methods. This approach enable us to effectively match the thermal, expansion properties of the metallic bond coat to the ceramic top coat and at the same time effectively fill the valleys at the thermal-sprayed bond coat and reduce the interfacial stresses in these thermally sprayed coatings. Since both of these scenarios were contributing factors leading to delamination/decohesion failures in TBC's, a substantial improvement in the fatigue life of TBC's was realized.

The foregoing description has been limited to a few embodiments of the invention. It will be apparent, however, that variations and modifications can be made to the invention, with the attainment of some or all of the advantages. Therefore, it is the object of the claims to cover all such variations and modifications as come within the true spirit and scope of the invention.

What is now claimed is:

1. An intermediate thermal expansion coefficient coating, said coating comprising an NiCoCrAly alloy.

2. The intermediate thermal expansion coefficient coating of claim 1, wherein the coating contains nanoparticles of said alloy and alumina.

3. A nanocomposite coating which is placed on metals to protect them from high gas temperatures by providing thermal insulation, said nanocomposite coating including a bond coating, an intermediate thermal expansion coefficient coating, and a ceramic top coat.

4. The nanocomposite of claim 3, wherein the intermediate thermal expansion coefficient coating comprises a NiCoCrAly alloy and allumina nanoparticles.

5. The nanocomposite of claim 3 wherein the ceramic top coat is based on zirconia or high purity alumina.
